(19) United States
(12) Patent Application Publication
(10) Pub. No.: US 2008/0248208 A1
(43) Pub. Date: Oct. 9, 2008

(54) APPARATUS AND METHOD FOR MEASURING THE QUANTITY OF CONDENSABLE MATERIALS WHICH OUTGAS DURING CURE OF ORGANIC THIN FILMS

(76) Inventors: Mark Stephen Chace, Beacon, NY (US); John Richard Graziano, Campbell Hall, NY (US); Ranee Wai-Ling Kwong, Wappingers Falls, NY (US); Margaret C. Lawson, LaGrangeville, NY (US); Alfred Oscar Passano, Wappingers Falls, NY (US)

Correspondence Address: SCHMEISER, OLSEN & WATTS, 22 CENTURY HILL DRIVE, SUITE 302, LATHAM, NY, 12110, US

(21) Appl. No.: 11/697,403

(22) Filed: Apr. 6, 2007

(51) Int. Cl. B05D 3/02; B05C 11/00

(52) U.S. Cl. 427/384; 118/699

(57) ABSTRACT

An apparatus and method for measuring an amount of condensable material which outgas during cure of organic thin films. The apparatus includes a hotplate placed in a chamber having a removeable liner and means for cooling the liner. The method includes: weighing the liner, sequentially placing multiple substrates on said hotplate, and then weighing the liner again.

### FIELD OF THE INVENTION

The present invention relates to the field of characterizing condensable materials which outgas from organic films during heating; more specifically, it relates to an apparatus and a method for characterizing the condensable materials which outgas from organic films during heating.

### BACKGROUND OF THE INVENTION

Many organic materials, when formed into a thin layer on a substrate, outgas volatile components that can condense out on processing equipment. This can cause significant maintenance, process defects, and/or process performance degradation particularly in the lithographic processes of the semiconductor industry. Therefore, there is a need to evaluate the volatility of organic materials prior to introduction of the materials into a manufacturing environment.

### SUMMARY OF THE INVENTION

A first aspect of the present invention an apparatus, comprising: a chamber having top and sidewalls and open at a bottom, the chamber divided into an upper region and a lower region by a removeable plate, the sidewalls in the lower region covered by a removeable liner, means for introducing and controlling the flow rate of a coolant gas into the upper region of the chamber; a hotplate positioned in the lower region of the chamber, the hotplate controllable to a temperature greater than room temperature; and a first slot in the sidewall in the lower chamber, the first slot aligned with a second slot in the liner, the first and second slots adapted to allow introduction of a substrate into the chamber and placement on the hotplate.

A second aspect of the present invention is a method, comprising, in the order recited: (a) weighing a plate and a liner to establish a tare weight; (b) providing a chamber having top and sidewalls and open at a bottom; (c) removeably mounting the plate in the chamber, the plate dividing the chamber into an upper region and a lower region; (d) removeably mounting the liner on the sidewalls in the lower region of the chamber; (e) introducing and controlling the flow rate of a coolant gas into the upper region of the chamber; (f) coating a set of substrates with an organic material to generate a set of coated substrates; (g) placing a coated substrate of the set of coated substrates on a hotplate positioned in the lower region of the chamber, the hotplate controlled to a temperature greater than room temperature; (h) after a fixed period of time removing the coated substrate from the hotplate; (i) repeating steps (g) and (h) for each coated substrate of the set of coated substrates; (j) removing the plate and the liner from the chamber; (k) weighing the plate and liner to obtain a post-test weight; and (l) subtracting the tare weight from the post-test weight to determine a weight of material, if any, condensed onto the plate and liner

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 is a cross-sectional view through an apparatus for collecting condensable materials from an organic film according to the present invention; and

FIG. 2 is flowchart of a method for determining the acceptability of an organic material for use in a manufacturing environment using the apparatus of FIG. 1.

### DETAILED DESCRIPTION OF THE INVENTION

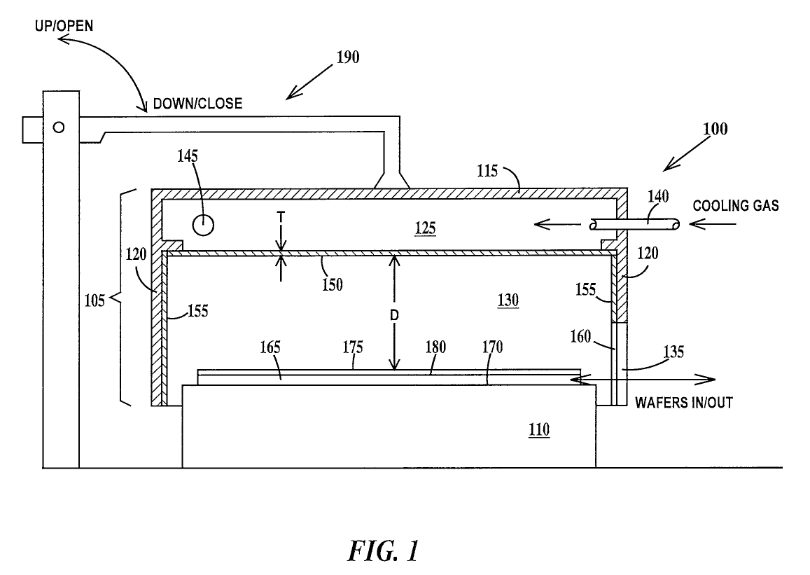

FIG. 1 is a cross-sectional view through an apparatus for collecting condensable materials from an organic film according to the present invention. In FIG. 1, an apparatus 100 includes a test chamber 105 and a hotplate 110. Chamber 105 includes a top 115 and sidewalls 120 and is divided into and upper region 125 and a lower region 130. A slot 135 in sidewall 120 of chamber 105 allows passing of test substrates (e.g. wafers) in and out of lower region 130. Upper region 125 is fitted with a cooling gas inlet 140 and an outlet 145. An upper removable and disposable collection plate 150 separates upper region 125 from lower region 130 of chamber 105. A removable and disposable sidewall liner 155 lines inner surfaces of sidewalls 120 in lower region 130. Plate 150 prevents coolant gas from entering lower region 130. Cooling gas entering lower region 130 of chamber 105 would reduce the amount of condensables collected on plate 150 and liner 155, by sweeping away the liberated condensables before they contact the plate and liner. A slot 160 in liner 155 of chamber 105 allows passing of test substrates in and out of lower region 130. In one example, plate 150 and liner 155 have a thickness T equal to between about 0.016 mm and about 0.024 mm. In one example, plate 150 and liner 155 are formed aluminum foil. It is advantageous that plate 150 and 155 be easily (e.g. by hand) compacted for weighing and easily (e.g. by hand) returned to shape for mounting in chamber 105.

In FIG. 1, a test substrate 165 is shown on a top surface 170 of hotplate 170 and an organic film 175 has been formed on a top surface 180 of substrate 165 prior to placing the substrate into chamber 105. Organic film 175 is positioned a distance D from plate 150. In one example, D is between about 20 mm and about 40 mm. In one example, substrate 165 is a silicon wafer. In one example, substrate 165 is a silicon wafer having a diameter of 8 inches.

Chamber 105 is mounted to a rotatable arm 190 that is illustrated in the up position, allowing easy access to the interior of chamber 105 to place or remove plate 150 and liner 155 from the chamber. In the down position, arm 190 positions chamber 105 so wafer 165 and an upper portion of hotplate 110 are within lower region 130 of the chamber. Plate 150 and liner 155 may be held in place in chamber 105 by spring clips (not shown). Apparatus 100 may also include a robot (not shown) for moving substrates from a cassette of substrates to hotplate 110 and from hotplate 110 back to the cassette.

It is advantageous for the shape of chamber 105 and the shapes of plate 150 and liner 155 to conform to the shape of substrate 165. In the example, that substrate 165 is a circular wafer, chamber 105 would be a cylinder, plate 150 would be disc-shaped and liner 155 would be cut to be rectangular in shape and then formed into a cylinder. It is advantageous for plate 150 and liner 155 to be as light-weight as possible in order to reduce the errors in weighing the small quantities of residuals that will be deposited on the liners during testing. It is advantageous that plate 150 and 155 be easily (e.g. by hand) compacted (reduced in spatial extent, for example, by rolling or folding) for weighing and easily (e.g. by hand) returned to shape for mounting in chamber 105.

A condensable is defined as material given off by an organic film when heated above room temperature, the condensable being a solid or non-volatile residue at room temperature. A solvent is defined as material given off by an organic film when heated above room temperature that is a liquid at room temperature. The temperature of the hotplate is adjusted high enough above room temperature so solid condensables are driven off and the cooling gas flow rate is adjusted to maximize the quantity of solid condensables collected and to minimize the amount of liquid solvents collectables that are also driven from the organic film. In one example, hotplate 105 is set for between about 140° C. to about 300° C. and the flow of cooling gas is selected to maintain the temperature of plate 150 at about 35° C. or higher. In one example, hotplate 105 is set for between about 140° C. to about 300° C. and the flow of cooling gas is selected to maintain the temperature of plate 150 above the dew point of the solvent being emitted from organic film 175.

Examples of organic thin films include photoresists, anti-reflective coatings, ancillary coatings, and adhesion promoters. Examples of condensables include, but are not limited to sensitizers (material reactive to actinic radiation), photo-acid generators and cross-linking agents.

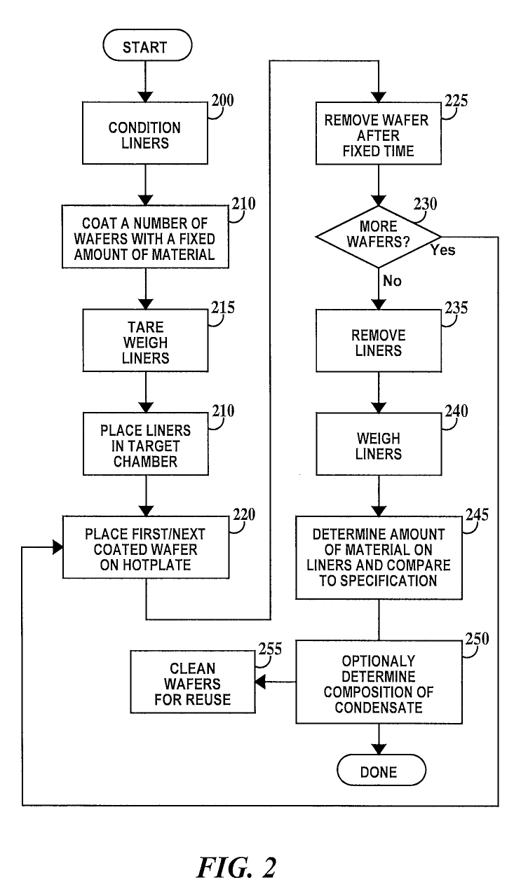

FIG. 2 is flowchart of a method for determining the acceptability of an organic material for use in a manufacturing environment using the apparatus of FIG. 1. The steps of FIG. 2 will be described in terms of a circular wafer substrate, but are applicable to almost any shaped substrate. In step 200, a liner pair (upper and sidewall liners) are conditioned by heating to drive off any materials present that could interact with the condensables collected. In one example, the liners are heated to a temperature of 25° C. higher than the temperature of the hotplate in a nitrogen oven and then hermitically sealed or otherwise stored in a clean inert atmosphere.

In step 205 a group of wafers of a fixed number (e.g. 50 to 100) are each coated with the same amount of a same material to be tested for condensables. In one example, a milliliter of material is dispensed onto to the top surface of each wafer and the wafer spun to form a thin film of the material on the top surface of the wafer. Optionally, the thickness of the film may be measured and the amount of material dispensed or the spin conditions adjusted to give a predetermined film thickness.

In step 210 a conditioned liner pair are weighed to determine their tare weight and in step 215, the weighed conditioned liner pair are installed in the test chamber.

In step 220, the first/next wafer of the group of coated wafers is placed on the hotplate. In step 225, the wafer placed on the hotplate in step 220 is removed after a fixed amount of time. In one example, the fixed amount of time is between about 10 seconds and 1 minute.

In step 230, it is determined if there are more wafers in the group of wafers to be processed. If there are more wafers the method loops back to step 220, otherwise the method proceeds to step 235. In step 235, the liners are removed and in step 240, the liners are weighed.

In step 245, the weight of material collected (condensate) on the liners is determined by comparing the weight obtained in step 240 with the tare weigh obtained in step 210. The weight of material may be compared to a specification to determine the suitability of the material for use in the manufacturing environment.

Optionally, in step 250, the composition of the condensate collected on the liners may be determined by chemical analysis. Optionally in step, 255 the wafers are cleaned (e.g. in an oxygen plasma) and stored for reuse.

Thus the present invention provides an apparatus and method to evaluate the volatility of organic materials prior to introduction of the materials into a manufacturing environment.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. An apparatus, comprising:
a chamber having top and sidewalls and open at a bottom, said chamber divided into an upper region and a lower region by a removeable plate, said sidewalls in said lower region covered by a removeable liner,
means for introducing and controlling the flow rate of a coolant gas into said upper region of said chamber;
a hotplate positioned in said lower region of said chamber, said hotplate controllable to a temperature greater than room temperature; and
a first slot in said sidewall in said lower chamber, said first slot aligned with a second slot in said liner, said first and second slots adapted to allow introduction of a substrate into said chamber and placement on said hotplate.

2. The apparatus of claim 1, wherein said plate and said liner comprise a metal foil.

3. The apparatus of claim 1, wherein said plate and said liner comprise aluminum foil.

4. The apparatus of claim 1, wherein said plate and said liner independently have a thickness no greater than about 0.024 mm.

5. The apparatus of claim 1, further including:
a cassette of substrates coated with an organic material;
means for sequentially loading substrates from said cassette onto said hotplate and unloading said substrates from said hotplate after being on said hotplate for a fixed period of time, no more than substrate on said hotplate at any given time.

6. The apparatus of claim 1, further including:
means for removing said chamber from over said hotplate.

7. A method, comprising, in the order recited:
(a) weighing a plate and a liner to establish a tare weight;
(b) providing a chamber having top and sidewalls and open at a bottom;
(c) removeably mounting said plate in said chamber, said plate dividing said chamber into an upper region and a lower region;
(d) removeably mounting said liner on said sidewalls in said lower region of said chamber;
(e) introducing and controlling the flow rate of a coolant gas into said upper region of said chamber;
(f) coating a set of substrates with an organic material to generate a set of coated substrates;
(g) placing a coated substrate of said set of coated substrates on a hotplate positioned in said lower region of said chamber, said hotplate controlled to a temperature greater than room temperature;
(h) after a fixed period of time removing said coated substrate from said hotplate;
(i) repeating steps (g) and (h) for each coated substrate of said set of coated substrates;
(j) removing said plate and said liner from said chamber;
(k) weighing said plate and liner to obtain a post-test weight; and
(l) subtracting said tare weight from said post-test weight to determine a weight of material, if any, condensed onto said plate and liner.

8. The method of claim 7, wherein said plate and liner comprise aluminum foil.

9. The method of claim 7, wherein said organic material is photoresist.

10. The method of claim 7, further including:
(m) after step (l), performing a chemical analysis of said any material condensed onto said plate and liner.
